(19) United States
(12) Patent Application Publication
(10) Pub. No.: US 2018/0255808 A1
(43) Pub. Date: Sep. 13, 2018

(54) DISSOLVING FLAVOR CANDY

(71) Applicant: DONNA ROYSTON, HOUSTON, TX (US)

(72) Inventor: DONNA ROYSTON, HOUSTON, TX (US)

(21) Appl. No.: 15/920,148

(22) Filed: Mar. 13, 2018

Related U.S. Application Data
(60) Provisional application No. 62/470,462, filed on Mar. 13, 2017.

(51) Int. Cl. A23L 2/56; A23L 2/60; A23F 3/40; A23F 5/46

(52) U.S. Cl. CPC A23L 2/56; A23L 2/60; A23V 2200/15; A23F 5/465; A23V 2002/00; A23F 3/405

(57) ABSTRACT

A dissolving flavor candy for use in a hot drink includes a candy portion and a handle portion. The candy portion is designed or formed into a singular solid substance for easy packaging and transportation. The candy portion may include one or more additives either mixed or layered within itself to alter any of the taste, health, and pleasurability of the hot drink. The additives may be used to provide options for various flavor profiles as the candy portion is dissolved into the hot drink. The handle portion is coupled to the candy portion to aid in handling of the candy portion and manipulation thereof.

### CLAIM OF PRIORITY

This application claims the benefit of U.S. Provisional Application No. 62/470,462, filed 13 Mar. 2017. The information contained therein is hereby incorporated by reference.

### BACKGROUND

### 1. Field of the Invention

The present application relates generally to a dissolvable flavor product designed for use with a hot drink.

### 2. Description of Related Art

Hot drinks such as coffee and tea are commonly accepted and relatively popular. These drinks may be taken in different ways. Although some drink them straight, many choose to put some form of additive, such as cream, sugar, honey, spice, or even liquor. Specialty coffees are also popular. Most of these additives are found in liquid form. It is difficult to add or carry these items while traveling due to the risk of spilling. Additionally, not all ingredients may be stored at room temperature.

Although great strides have been made with respect to the method of making coffee in accordance with personal taste, considerable shortcomings remain. A new method of providing additives for hot drinks is needed that is more suitable to the busy lifestyles and fast paced trend of adults.

### SUMMARY OF THE INVENTION

It is an object of the present application to provide a dissolving flavor candy or beverage enhancer for introducing flavor to a hot drink. The flavor candy of the present application is a fully transportable hardened candy like substance. It is packaged easily and ready for use when removed from the packaging. The flavor candy is configured to dissolve in the hot drink at a selected rate. A user is able to regulate the amount of flavor candy dissolved into the hot drink by removing the flavor candy from the drink when the desired potency and flavor is reached. It is a further object of the present application to describe a method of flavoring a drink wherein the flavoring substance is collectively assembled into a singular mass. Furthermore, the flavor candy may include one or more layers of flavor having different potency. The flavors may be different between the layers. Ultimately the invention may take many different embodiments. In this way, the dissolving flavor candy overcomes the disadvantages inherent in the prior art.

The more important features of the dissolving flavor candy have thus been outlined in order that the more detailed description that follows may be better understood and to ensure that the present contribution to the art is appreciated. Additional features of the dissolving flavor candy will be described hereinafter and will form the subject matter of the claims that follow.

Many objects of the dissolving flavor candy will appear from the following description and appended claims, reference being made to the accompanying drawings forming a part of this specification wherein like reference characters designate corresponding parts in the several views.

Before explaining at least one embodiment of the dissolving flavor candy in detail, it is to be understood that the dissolving flavor candy is not limited in its application to the details of construction and the arrangements of the components or ingredients set forth in the following description or illustrated in the drawings. The dissolving flavor candy is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and candies for carrying out the various purposes of the dissolving flavor candy. It is important, therefore, that the claims be regarded as including such equivalent constructions insofar as they do not depart from the spirit and scope of the present candy.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of a dissolving flavor candy according to an embodiment of the present application.

FIG. 2 is a side view of the dissolving flavor candy of FIG. 1 in use with a mug.

While the dissolving flavor candy and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the dissolving flavor candy is depicted in the attached drawings. However, as will be recognized by those skilled in the art after a complete reading of the present application, the parts, members, elements, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the dissolving flavor candy described herein may be oriented in any desired direction.

The dissolving flavor candy and method in accordance with the present application overcomes one or more of the above-discussed problems commonly associated with the prior art in the background section. In particular, the dissolving flavor candy provides a time released flavor additive to a hot drink. The body of the dissolving flavor candy is configured to be soluble wherein the rate of solubility can change in accordance with temperature of the liquid substance and variation of the additives (i.e. concentration and type of additive) within the candy portion. The dissolving flavor candy is transportable without fear of spills or spoilage. Exposure to the liquid substance can help regulate the potency of the flavor in the liquid substance. These and other unique features of the assembly are discussed below and illustrated in the accompanying drawings.

The dissolving flavor candy and method will be understood, both as to its structure and operation, from the accompanying drawings, taken in conjunction with the accompanying description. Several embodiments of the dissolving flavor candy may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The dissolving flavor candy and method of the present application is illustrated in the associated drawings. The dissolving flavor candy includes a candy portion and a handle portion. The candy portion is designed or formed into a singular solid substance for easy packaging and transportation. The candy portion may include one or more additives either mixed or layered within itself to alter the any of the taste, health, and pleasurability of the hot drink. Additional features and functions of the device are illustrated and discussed below.

Referring now to the Figures wherein like reference characters identify corresponding or similar elements in form and function throughout the several views. The following Figures describe the assembly of the present application and its associated features. With reference now to the Figures, an embodiment of the modular observation assembly and method of use are herein described. It should be noted that the articles “a”, “an”, and “the”, as used in this specification, include plural referents unless the content clearly dictates otherwise.

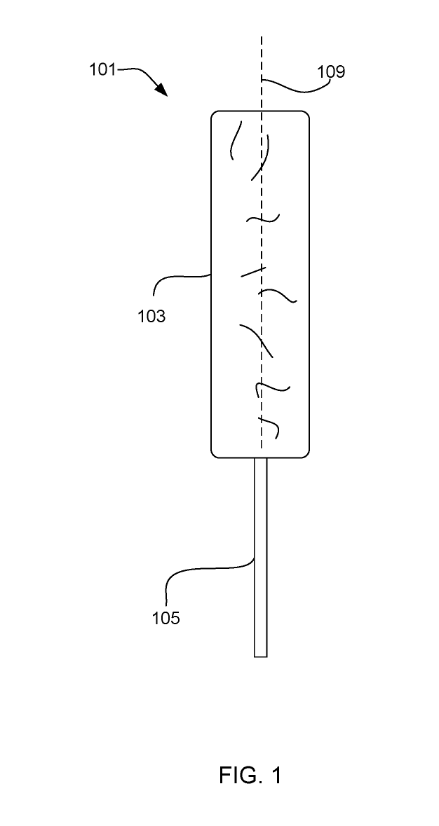

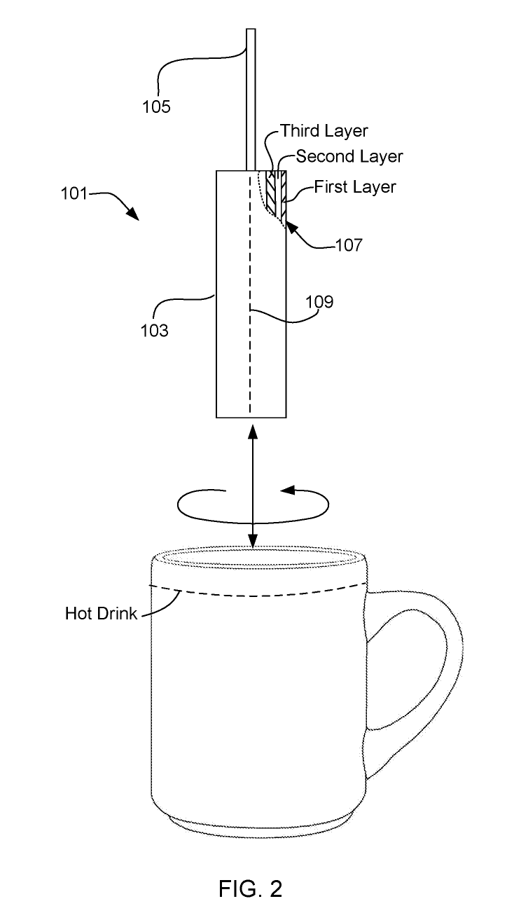

Referring now to FIGS. 1 and 2 in the drawings, a dissolving flavor candy is illustrated. Dissolving flavor candy 101 includes a candy portion 103 and a handle portion 105. Candy 101 is configured to locate candy portion 103 in an exposed manner such that it surrounds a portion of handle 105. Candy portion 103 includes one or more additives for introducing into the hot drink. This is done by dipping a portion of candy portion 103 into the hot drink and allowing it to dissolve, at least partially. The amount of time to dissolve, or the rate of dissolving, can be influenced by the temperature of the drink. By selectively removing the candy portion 103 from the drink, a user is able to regulate the amount of additives that are dissolved into the drink. It is understood that other types of drinks, besides hot drinks, are also considered as suitable drinks with candy 101.

Candy portion 103 is designed to be a hardened substance composed of one or more additives. The additives 107 are selectively mixed and hardened in accordance with desired compositions to form a singular hardened solid mass. Examples of typical additives may be creamer, flavoring, and sugar. The proportions of each additive 107 in comparison to the whole may also be adjusted at the time of creation. Variation of each in proportion to another can affect the potency of candy portion 103. A way to affect potency in the drink is to allow more of the additives to be dissolved in the liquid. It is understood that the additives can be formed into a singular mixture encompassing the entire candy portion 103 as described above.

Alternatively, each additive 107 may be layered relative to another additive 107 as seen in the partial section view in FIG. 2. This layering can influence potency, flavor, and/or sweetness. It is understood that the layering may be oriented longitudinally along the full or partial length of the candy portion 103, differentiated from a central axis 109 (as pictured); or the layers may be oriented circumferentially/horizontally about its width, stacked along axis 109. Other orientations are possible and included herein.

For example, if layering is used with the additives 107 the outer layers will be dissolved prior to internal layers if layered longitudinally. Candy portion 103 can include a layering profile that is designed to adjust any of flavor, sweetness, or any other quality in stages as dissolving happens. Multiple flavors that are complimentary may be introduced. A first flavor may be the outer most layer. A sweetened layer may be the next interior layer. The third inner layer may be a secondary flavor used to alter the flavor profile introduced in the outer layer. This could allow a singular dissolving flavor candy 101 to have multiple flavor options for a user. Each flavor option could be dependent upon the rate of dissolving and length of time within the liquid. Although described herein with layering to affect the flavor, other additives may be layered, such as supplements (i.e. caffeine, extracts, medicinal matter, plant and mineral ingredients to name a few), energy/enhancement ingredients, sugars, creamer, and so forth. An advantage of dissolving flavor candy 101 is the ability to give a user to take a plane ordinary unaltered drink and create a customized sweetened and flavored drink by merely carrying a singular solid mass as opposed to multiple flavor powders, liquids, creamers, and sugars.

Handle portion 105 is configured to communicate with candy portion 103 so as to provide a suitable and stable object for the user to hold onto. This avoids the user having to touch candy portion 103. Hands are then left without candy residue and overall sanitation is increased. Manipulation of handle 105 induces movement of candy portion 103 relative to the hot drink. Although handle portion 105 has been included in candy 101, it is understood that some embodiments may not necessitate its use or inclusion. It is conceived that candy portion 103 may be made in a singular tablet size that is merely dropped into the hot drink. A spoon could be used to stir it around and remove it if necessary. However, a good portion of coffee or other hot drinks are served in containers with lids unsuitable for spoon usage. Removing or negating the need of handle portion 105 could act to hinder many of the advantages described herein.

To use the dissolving flavor candy 101 of the present application, a user would acquire one or more quantity of candies, each would have a candy portion 103 and should include a handle portion 105. These can be sold in packages of varied amounts. The packages may include varied potencies of candies and also varied flavors. The user merely has to select the desired candy for use at the appropriate time. The candies are prepackaged in individual quantities such that each candy portion 103 is covered in a protective wrap. These can be carried in a pocket, purse, bag, and so forth of the user. At the appropriate time, the packaging is removed and the candy portion 103 is inserted into the drink. A user may grasp handle portion 105 to stir the dissolving candy portion 103 by swirling it in the hot drink. This may help to increase the rate of dissolving. The user may check the potency of the drink by taking a sip or by removing candy portion 103 from the drink to look at it so as to gauge the amount that has dissolved. When the drink is acceptable, the user may use handle portion 105 to withdraw candy portion 103. The user may selecting a flavor profile and permit the candy portion to dissolve for a particular time frame so as to reach the flavor profile. The flavor profile can be dependent upon the mixing of a plurality of additive layers within the candy portion into the hot drink.

Particular advantages of system 101 include at least the following: (1) a fully transportable hardened flavoring and sweetening candy for use in a hot drink; (2) ability to regulate the degree of potency of the drink from the dissolving candy; (3) candy does not need refrigerated; and (4) a user may maneuver or manipulate the candy without soiling the hands/fingers.

It is evident by the foregoing description that the subject application has other significant benefits and advantages. The present assembly and method is amenable to various changes and modifications without departing from the spirit thereof. The particular embodiments disclosed above are illustrative only, as the system and method may be modified and practiced in different but equivalent manners apparent to those skilled in the art having the benefit of the teachings herein. It is therefore evident any alterations, modifications, and all such variations are considered within the scope and spirit of the application. It is apparent that a system and method with significant advantages has been described and illustrated.

What is claimed is:

1. A dissolving flavor candy for a hot drink, comprising:
a candy portion formed into a singular hardened mass having one or more additives; and
a handle portion coupled to a portion of the candy portion;
wherein the candy portion is configured to be soluble in the hot drink thereby selectively introducing the one or more additives into the hot drink.

2. The candy of claim 1, wherein the candy portion includes a plurality of layers of additives.

3. The candy of claim 2, wherein the plurality of layers being a different and unique additive.

4. The candy of claim 2, wherein the plurality of layers includes a supplement.

5. The candy of claim 2, wherein the plurality of layers are sorted so as to provide a selection of flavor options.

6. The candy of claim 2, wherein the plurality of layers of additives extend longitudinally along the full length of the candy portion, the plurality of layers being differentiated by distance from an axis.

7. The candy of claim 2, wherein the plurality of layers of additives are stacked circumferentially to form multiple layers along an axis of the candy portion.

8. The candy of claim 1, wherein the candy portion includes a singular additive.

9. The candy of claim 1, wherein the candy portion includes a plurality of additives in a singular mixture.

10. The candy of claim 1, wherein the candy portion is configured to have different soluble rates.

11. The candy of claim 1, wherein at least one of the potency and the flavor of the additive in the candy portion influences the flavor of the hot drink.

12. The method of altering the flavor of a hot drink, comprising:
obtaining a dissolving flavor candy having a candy portion formed into a singular hardened mass having one or more additives and a handle portion coupled to a portion of the candy portion;
unwrapping the candy portion;
dipping the candy portion into the hot drink to dissolve a portion of the candy portion.

13. The method of claim 12, further comprising:
swirling the candy portion in the hot drink to increase the rate of dissolving.

14. The method of claim 12, further comprising:
withdrawing the candy portion from the hot drink.

15. The method of claim 12, further comprising:
selecting a flavor profile and permitting the candy portion to dissolve for a particular time frame so as to reach the flavor profile.

16. The method of claim 15, wherein the flavor profile is dependent upon the mixing of a plurality of additive layers within the candy portion into the hot drink.
